(19) United States
(12) Patent Application Publication
(10) Pub. No.: US 2014/0006148 A1
(43) Pub. Date: Jan. 2, 2014

(54) SYSTEM AND METHOD FOR MESSAGING SYSTEM

(71) Applicant: CUSTOM TELECONNECT, INC., Las Vegas, NV (US)

(72) Inventor: William L. Perna, Las Vegas, NV (US)

(73) Assignee: CUSTOM TELECONNECT, INC., Las Vegas, NV (US)

(21) Appl. No.: 14/012,851

(22) Filed: Aug. 28, 2013

Related U.S. Application Data
(63) Continuation-in-part of application No. 13/779,496, filed on Feb. 27, 2013.
(60) Provisional application No. 61/604,706, filed on Feb. 29, 2012.

(51) Int. Cl. H04L 12/58

(52) U.S. Cl. CPC H04L 12/58
USPC 705/14.49; 709/206; 705/40; 705/14.4; 29/592

(57) ABSTRACT

In various embodiments described herein a messaging system is described. The messaging system may be useful in a correctional facility or other environments such as college campus, hospitals or other institutions. In addition to providing messaging service from a source to a destination, the system can perform additional functions for example, validating destination numbers, maintaining user records and storing message details.

### RELATED APPLICATION

This application is a continuation-in-part of U.S. application Ser. No. 13/779,496, filed on Feb. 27, 2013, titled “System and Method for Messaging System” which is a non-provisional of U.S. Provisional Application No. 61/604,706, filed on Feb. 29, 2012, titled “System and Method for Messaging System.” The disclosure of each of the above identified application is hereby incorporated by reference herein in its entirety.

### BACKGROUND

This invention relates in general to the field of communication networks such as voice and data communication.

Recent advances in communication systems have enabled different forms of real-time and time shifting communication. Examples of real-time communication include telephony, mobile and cellular communication, instant messaging, internet telephony, teleconferencing, etc. Another form of communication is a short message service (SMS) that enables exchange of short messages over the plain old telephone system (POTS) network or over the GSM or cellular network. Various implementations of SMS systems can be examples of time shifting communication that use a store and forward mechanism to send a message.

### SUMMARY

Communication systems in correctional facilities may have additional requirements concerning security and providing connectivity. For example, in a correctional facility, it may be useful to keep track of the phone numbers to which calls are placed or messages are sent, the number of calls made or messages sent by a particular inmate, the number of calls placed or messages sent to a particular phone number, the dollar amount of the calls placed or messages sent by a particular inmate and other such details. It may also be advantageous in such communication systems to have the ability to record conversations or review messages that can be legally recorded or reviewed. It may be beneficial if these services can be provided at lower cost.

Generally service providers to correctional facilities have systems and equipments at the correctional facility that will perform some or all the functions listed above before connecting the inmate to the outside telephone number. The cost of provisioning and maintaining the systems at individual correctional facility can rapidly increase. Thus there is a need for an architecture that has systems at a few locations that can monitor, validate and connect calls from multiple correctional facilities. Further it may be advantageous if systems and devices at one or more correctional facilities can be provisioned, controlled and maintained from these locations.

### BRIEF DESCRIPTION

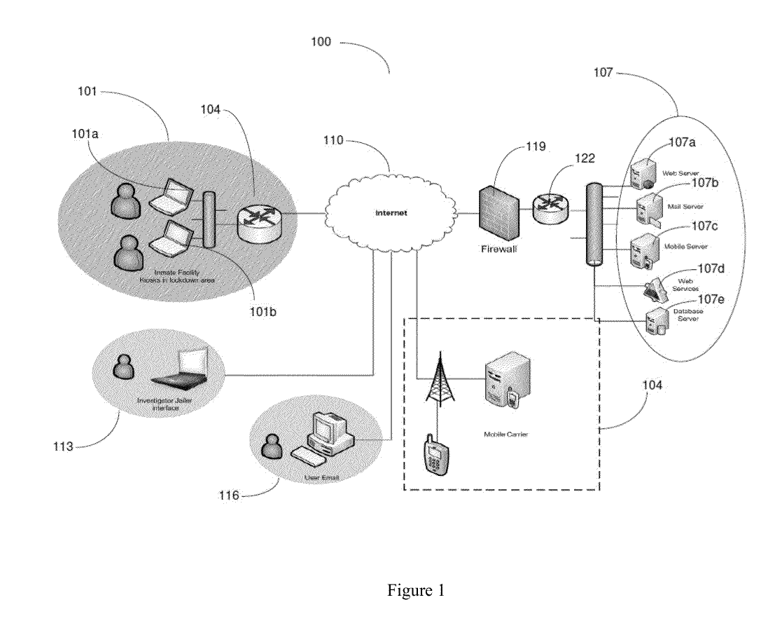

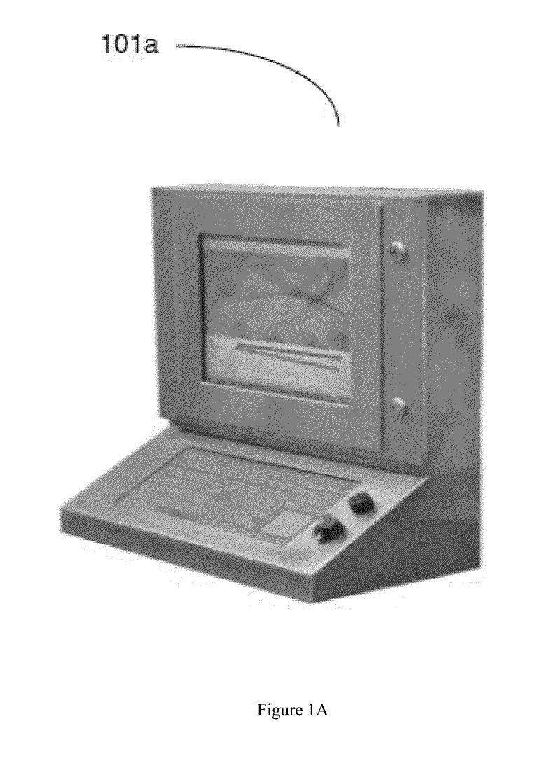

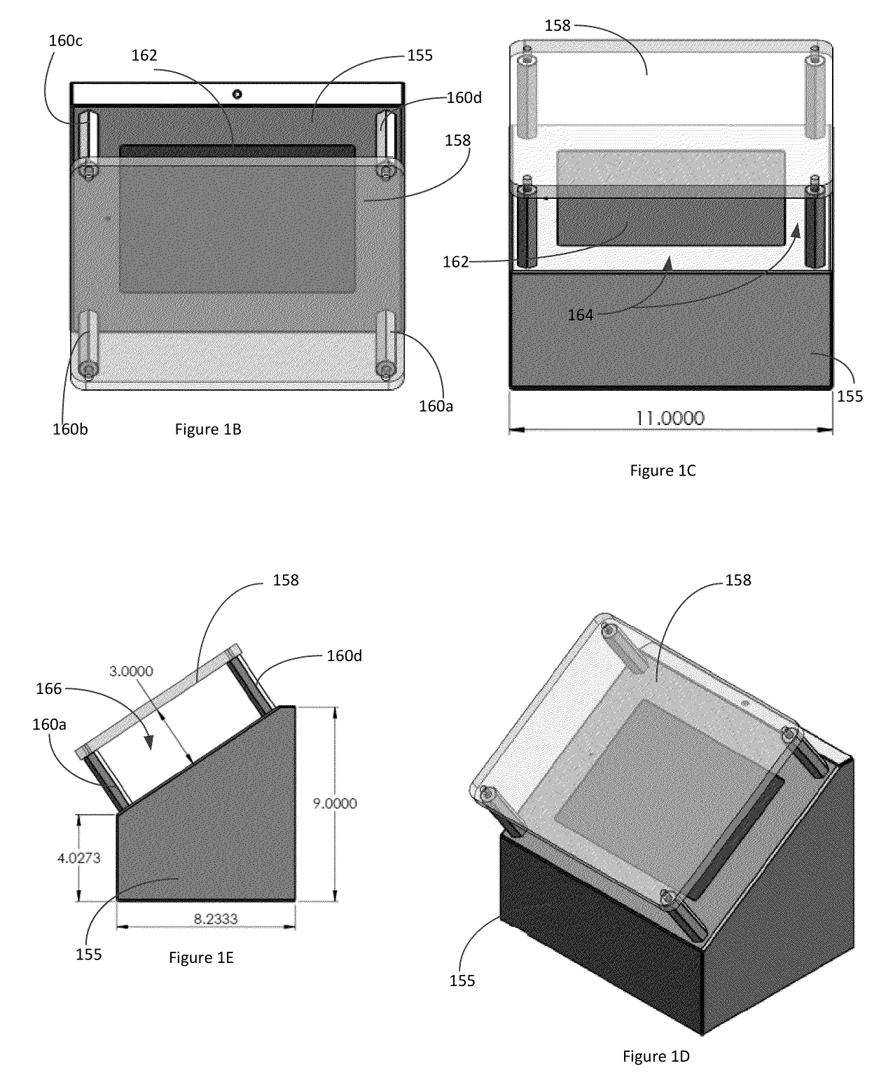

FIG. 1 illustrates an embodiment of a communication system that can be used to send messages from an institution to one or more persons outside the institution.

FIG. 1A illustrates an embodiment of a messaging kiosk that is a part of the communication system and can be installed in the institution.

FIGS. 1B-1E illustrate different views of an implementation of an enclosure to house the messaging kiosk.

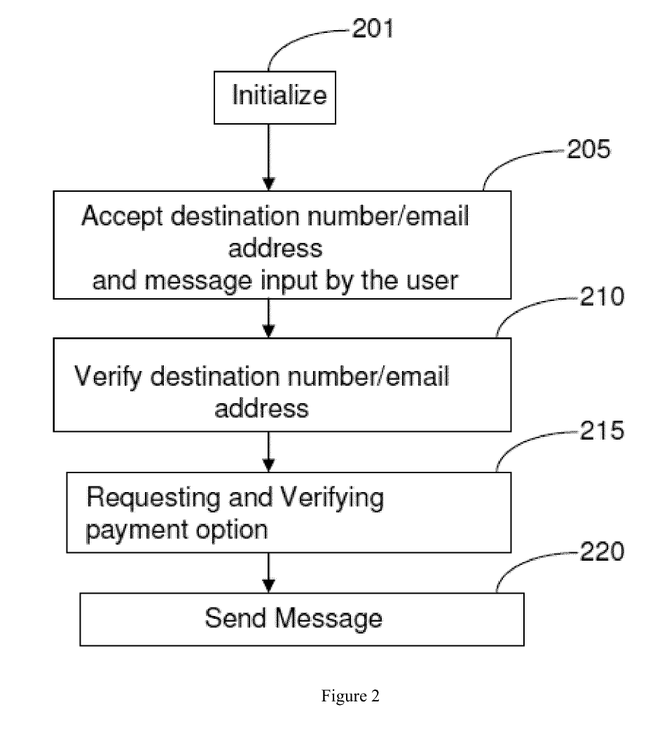

FIG. 2 is a flow chart illustrating a process of sending messages in one embodiment of the system.

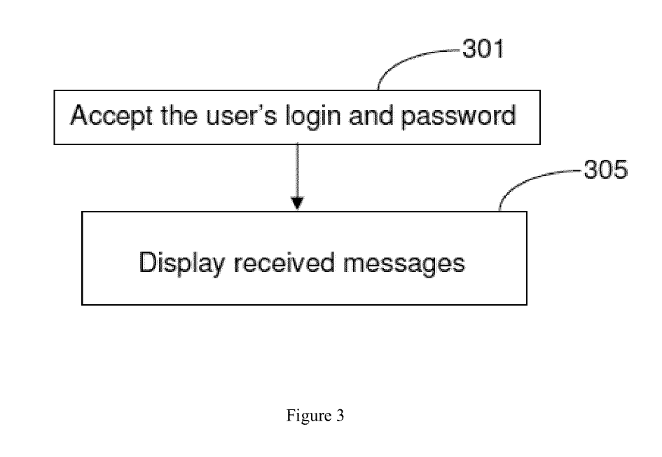

FIG. 3 is a flow chart illustrating a process of displaying received messages in one embodiment of the system.

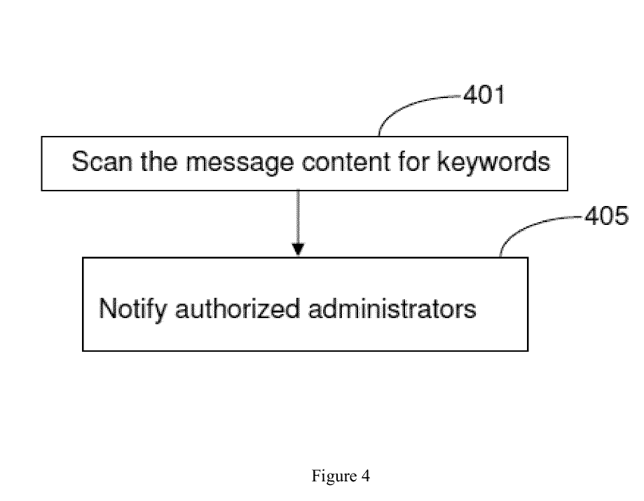

FIG. 4 is a flow chart illustrating the steps performed in the process of reviewing messages by an authorized administrator.

### DETAILED DESCRIPTION

The following detailed description is directed to certain specific embodiments of the invention. However the invention can be embodied in multiple ways. As will be apparent from the following description even though the invention is described in reference to correctional facilities, the embodiments described herein can be applied in other environments not limited to university/college campus, hospitals, military bases, schools, hotels and business organizations.

FIG. 1 shows an example of a communication system 100 that can be used to send messages from an institution to one or more persons outside the institution. The institution can include a correctional facility, a hospital, a learning institution (e.g. a college/university, a school, etc.), an airport, a hotel, a resort, etc. In one embodiment wherein the institution is a correctional facility, the communication system 100 can be used by inmates in the correctional facility to send and receive messages to one or more persons outside the correctional facility. The messages can be sent by the inmates to an email account or a cellular phone associated with the one or more persons outside the correctional facility. The inmates can also receive messages sent by one or more persons outside the correctional facility through a cellular phone or an email client. The system 100 includes a messaging station 101 that can be placed in a correctional facility. The messaging station 101 is in communication with the Internet 110 via a messaging station communication system 104. The messages sent from or to the messaging station 101 can be processed at a processing center 107 before being forwarded to a cellular phone associated with a mobile user 104 or delivered to an email account associated with a remote user 116. The processing center 107 can be connected to the Internet 110 through one or more cross-connects 122. In various implementations, the processing center 107 can be behind a firewall 119 to provide secure communication. In various implementations, the messaging station 101 can also be behind a firewall to provide secure communication. The communication system 100 can include one or more electronic and/or network interfaces 113 that can allow for secure review of the messages sent from or to the messaging station by an authorized administrator at the institution.

The messaging station 101 can include one, two or more messaging kiosks (e.g. messaging kiosks 101a and 101b). The messaging kiosk 101a can include a display device, a message input interface, a messaging kiosk processor and a messaging kiosk communication system. In various implementations, the messaging kiosk 101a can include a desktop computer, laptop computer, a tablet PC, an IPAD®, etc. For instance, the messaging kiosk 101a can be implemented (e.g. in an application) in a mobile device, smartphone, tablet computing device, or other portable computing device. In various implementations, the message input interface can be a physical or a virtual keyboard. An implementation of a messaging kiosk is illustrated in FIG. 1A.

In various implementations, the messaging kiosks 101a and 101b can include a mobile computing system such as, for example, a laptop computer, a tablet PC, an IPAD®, etc. Although, a mobile computing system is configured to be mobile and easily portable, for some applications it may be advantageous to house them in an enclosure such that they are not easily portable. For example, light-weight, easily portable mobile computing system can be housed in an enclosure to prevent theft or damage from vandalism. For various applications, it is advantageous to configure the enclosure such that a user can easily access the mobile computing system to perform various functions and access various mobile applications without being able to move or damage the mobile computing system. Accordingly, the enclosure can have openings or gaps that allow users to access an input interface (e.g., a touch surface, a physical or a virtual keyboard, a mouse, etc.) of a mobile computing system (e.g., an IPAD®) to open various mobile applications, send messages, access the internet, etc.

FIGS. 1B-1E illustrate different views of an implementation of an enclosure. The enclosure comprises a base 155. In various implementations, the base 155 can comprise materials such as, for example, plastic, composite materials, metal, wood, bamboo, plexi-glass, fiber glass, etc. In various implementations, the base 155 can include materials that can withstand wear and tear. In various implementations, the base 155 can include materials that are shatterproof. In various implementations, the base 155 can include materials that are break resistant. In various implementations, the base 155 can include materials that are bullet proof. In various implementations, a height of the base 155 can be between about 4 inches to about 24 inches. A width of the base 155 can be between about 4 inches and about 24 inches. A breadth of the base 155 can be between about 4 inches and about 24 inches. In various implementations, the base 155 can have a height between about 6 inches to about 5 feet. For example, the base can have a height of about 12 inches, about 18 inches, about 24 inches, about 30 inches, about 36 inches, about 42 inches, about 48 inches, about 54 inches and about 60 inches. In various implementations, the enclosure can be mounted on a pedestal or a support platform.

In various implementations, a top surface 156a of base 155 can be inclined with respect to a bottom surface 156b of the base 155 such that the mobile computing device is easily viewed by one or more users. To facilitate ease of viewing, the top surface 156a of the base 155 can be inclined at an angle between about 30 degrees and about 45 degrees with respect to the bottom surface 156b.

The top surface 156a can include a recess 162 that is configured to receive and accommodate different mobile computing systems. For example, the recess 162 can have dimensions to accommodate an IPAD®. In various implementations, the recess 162 can have dimensions such that the top surface of the mobile computing system is in the same plane as the top surface 156a of the base 155. In other words, the recess 162 can have a depth such that the top surface of the mobile computing system is in the same plane as the top surface 156a of the base 155. In various implementations, the recess 162 can have dimensions such that the mobile computing system is disposed without any gaps or spaces between the edges of the mobile computing system and the edges of the recess 162. In various implementations, the recess 162 can have dimensions such that the mobile computing system fits seamlessly within the recess 162. The recess 162 can be formed in a central portion of the top surface 156a of the base 155 such that there exists a border 164 around the recess 162.

The recess 162 can have fastening systems such as threaded or non-threaded holes for receiving screws, clips, cables, chains, etc. for securing the mobile computing system within the recess. For example, in various implementations, an IPAD® can be secured with screws in the recess 162. In various implementations, the mobile computing system can be adhered to the surface and the edges of the recess using glue or other adhesives.

The enclosure includes a cover 158 disposed over the top surface 156a of base 155. Accordingly, when a mobile computing system is disposed in the recess 162, the cover 158 is also disposed over the mobile computing system. In various implementations, the cover 158 is configured to prevent damage to the mobile computing system such as, for example, from accidental spills of liquid, or physical force. In various implementations, the cover 158 can be non-removably attached to the base 155. In various implementations, a portion of the cover 158 can be attached to the top surface 156a with hinges. In various implementations, the cover 158 can be separated from a top surface 156a of the base 155 and supported over the recess 162 by support structures 160a, 160b, 160c and 160d. In various implementations, the support structures 160a-160d can comprise one or more posts.

In various implementations, the cover 158 can be disposed such that it is parallel with the top surface 156a of the base 155. The cover 158 can be disposed such that a gap 166 is formed between the cover 158 and the top surface 156a of the base 155. The gap can have dimensions such that a user can access the mobile computing system disposed in the recess 162 with ease. For example, the height of the gap can vary between about 0.5 inches and about 6 inches to allow a user to easily access the mobile computing systems. In various implementations, the cover 158 can be disposed such that the height of the gap 166 is the same across the entire top surface 156a. In various implementations, the height of the 166 can vary across the top surface 156a.

In various implementations, the cover 158 can have dimensions that are substantially similar to the dimensions of the top surface 156a of the base 155. For example, the cover 158 can have a length between about 4 inches and about 24 inches and a width between about 4 inches and about 24 inches. The thickness of the cover 158 can be between about 0.5 inches and about 6 inches. In various implementations, the cover 158 can comprise materials that are transmissive to visible light. In various implementations, the cover 158 can comprise materials such as, for example, plastic, plexi-glass, fiber glass, alkali-alumino-silicate glass, borosilicate glass, etc. In various implementations, the support structures 160a-160d can include material such as plastic, plexi-glass, metal or a composite material. In various implementations, the cover 158 can include materials that are scratch resistant. In various implementations, the cover 158 can include materials that have a high hardness. For example, the hardness of the material of the cover 158 can be greater than about 500. In various implementations, the cover 158 can be provided with coating or filters that make data (e.g., text, video and/or images) displayed by the mobile computing system visible only to persons directly viewing the display of the mobile computing system. In some implementations, the cover 158 can include structures that make data (e.g., text, video and/or images) displayed by the mobile computing system visible only to persons directly viewing the display of the mobile computing system. In various implementations, the cover 158 and the support structures 160a-160d can include materials that can withstand wear and tear. In various implementations, the cover 158 and the support structures 160a-160d can include materials that are shatterproof. In various implementations, the cover 158 and the support structures 160a-160d can include materials that are break resistant. In various implementations, the cover 158 and the support structures 160a-160d can include materials that are bullet proof.

In various implementations, the messaging station 101 can send messages to and receive messages from one or more persons at remote locations from the institution via a messaging station communication system 104 that connects to the Internet 110. The messaging system communication system can include analog or digital switches, cross-connects, gateways, routers, etc. that can process the messages sent or received. Processing the messages sent or received can include scanning the messages for certain keywords, adding header and/or priority information to the messages, validating the phone number or the email address to/from which the messages are sent/received, make decision as to whether the message should be forwarded, flagged for review or dropped, computing/finding an optimum method and route to forward the message, etc.

In various implementations, the messages sent from or to the messaging station 101 can be further processed at a processing center 107. The processing center 107 can include a web server 107a, a mail server 107b, a mobile server 107c and a database server 107e. In various implementations, the processing center 107 can also include a processor that can provide web services 107d such as, for example, creating and managing account to send/receive messages, creating and managing an address book of contacts to send and receive messages, etc. The various servers and devices can be in communication with each other over a local area network (LAN). In some implementations, a single system may be used as a web server, a mail server, a mobile server, a database server and to provide web services. In various implementations, the processing center 107 can be associated (for example, include or be in communication with) a service center having a SMS platform.

In various implementations, the processing center 107 can identify the source and destination of the messages and confirm that there are sufficient funds to send or receive the messages. The processing center 107 can be involved in making the decision to forward the message based on various criteria (for example, having sufficient funds to complete the message, the telephone/mobile number or email address to which the message is sent or received from is verifiable, the message content being satisfactory, etc. The processing center 107 can make the decision to drop the message if one or more conditions are not met. Upon making the decision to forward the message to its destination, the processing center 107 can be involved in finding the optimal method and route to forward the message to its destination. The processing center 107 may additionally perform monitoring of the message, save the message and prepare billing statements. The processing center 107 may perform some or all of the functions listed above. In some embodiments, the processing center 107 may have additional capabilities not mentioned herein. Additional details about the systems and methods used to provide connectivity in the manner described above are disclosed in the following paragraphs.

Processing centers 107 may be placed at one or more geographical locations. The processing center 107 may range in complexity and functionality. For example, small processing centers with limited functionality and complexity may be placed within the system. The processing center 107 can include most of the call processing equipment. As discussed above, the processing center 107 can be connected to the Internet 110 via a cross-connect 122. However, in various implementations, the processing center 107 can be connected to the Internet 110 via a router, gateway device or a switch device. Additionally, in various implementations, the processing center 107 can also connect to the traditional Public Switched Telephone Network (PSTN) over a circuit or TDM switch such as a Class 4 Tandem Switch. In some embodiments, the processing center 107 can be connected to the PSTN via a Switch Termination Point (STP), a circuit switch or both.

The web server 107a can be configured to provide a software platform that delivers content to the World Wide Web (WWW). The web server 107a can also receive and interpret instructions and information from the WWW and use the same to update databases, provision and control the various sub-systems and components of the network described in FIG. 1. Thus the web server 107a can be used to provide means of provisioning, maintaining, updating, controlling and administering the various sub-systems of the communication system illustrated in FIG. 1 remotely using the WWW. The web server 107a can be in communication with other servers and systems in the processing center 107 over a LAN. The web server 107a can also be in communication with other processing centers, the messaging station 101, the Internet 110 and other networks and systems. In some embodiments, the web server 107a can include a proxy server to validate the incoming traffic to the processing center 107a.

The processing center 107a can also include a storage server which can provide access and control to a storage network. The storage server can be in communication with the other components and sub-systems of the processing center 107. The storage server can be used to store the message details, the content of the message and the billing information regarding the message. The storage server can be accessed internally by other systems of the processing center 107. The storage server can also be accessed from outside the processing center 107 through the web server 107a. The web server 107a can be configured to provide different levels of security so that information from the storage server that is in public domain can be accessed by all whereas information that is confidential and subject to privacy laws or some other privacy obligation such as attorney-client privilege, is only accessed by those authorized to do so.

The processing center 107 can be provided with a firewall server that manages the firewall 119. The firewall server is configured to allow valid and authenticated traffic from and into the processing center 107. Examples of valid traffic include requests from the WWW to access information that is in the public domain, incoming traffic from other processing centers, incoming traffic from the messaging station (e.g. messaging station 101) that are being provided service, information sent to the application server from a validated source over the WWW to access storage networks, information request from authorized personnel to access the messages sent or received, incoming messages from mobile phones or email clients, etc. The firewall 119 can be a hardware device or a software program that is configured to filter and direct valid traffic into the processing center 107. The firewall server can be standalone or be in communication with the other components of the processing center 107. In some embodiments, the firewall server can be administered by the web server 107a.

Each user at the messaging station 101 can have a messaging account that is associated with a unique login and password combination. The unique login and password combination can exist in a database located locally at the location where the messaging station 101 is located or at a remote location (for example, the web server 107a). In some embodiments, the unique login and password combination can exist on the Internet 110. A user at the messaging station 101 may have the option of sending messages in one of two ways; a debit process or a collect process. In some embodiments, a third option of sending messages using a credit card may also be provided. In one embodiment, in the debit process of sending a message, the user's account can be credited with a certain dollar amount via a web interface. The web interface can be configured to allow the user, the user's agent or representative to credit the user's account or to add prepaid increments to the user's account. The user's account can be debited as messages are sent or received. The amount debited can be proportional to the size of the message or on a per message basis. In some embodiments, a web interface can be used to credit the user's account. The web interface can also display the dollar amount used, the dollar amount remaining and the number of messages that can be sent with that dollar amount. The cost of sending the message can be determined by the service provider at the messaging station 101. In some embodiments, a separate web portal that can report revenue or dollar amount on a separate level can be built.

In one embodiment, in the collect process of sending a message, the user can send a message even if there is no dollar amount remaining in the user's account or there is no payment information associated with the account. In the collect method of sending a message, a financial account associated with the person receiving the message can be billed for the charges incurred by the user to send or receive a message. In various implementations, a request can be sent to the person receiving the message to accept or deny paying for the message sent by the user before forwarding the message.

If the user is allowed to send or receive messages using a credit card, then the charges incurred to send or receive the message can be billed to the credit card associated with the user. In various implementations, each user may be allowed to send and receive only a certain number of messages per 24 hours. For example, a user may be allowed to send and receive no more than 2, 4, 6, 8, 10 or 20 messages per 24 hours. In various embodiments the upper limit on the number of messages sent or received can be different. The upper limit on the number of messages sent or received can be changed for example, by using a web portal by the user.

FIG. 2 illustrates one embodiment of a method to send a message by a user at the messaging station 101. The method includes an initialization process as shown in block 201. The initialization process can include prompting the user to log into the account by providing the unique username and password combination; allowing the user to set-up an account associated with an username and password combination; allowing the user to reset the password or username; allowing the username to create or manage an address book; allowing the user to add a credit card or debit card information; allowing the user to add prepaid credits to the account, etc.

After initialization, the method proceeds to block 205 where the user is prompted to enter a destination number or email address and a message. The destination number or email address and the message provided by the user can be accepted by the processor at the messaging station 101. Accepting the destination number or email address and the message can include storing a part or all of the destination number or email address and/or the message locally in a memory at the messaging station 101 or remotely in a storage server (for example, at the processing center 107). Accepting the destination number or email address and the message can also include transmitting part or all of the destination number or email address and/or the message to the processing center 107 for further processing.

The method then proceeds to block 210 where the destination number/email address is verified. The verification of the destination number/email address can be done locally at the messaging station 101 or remotely (for example, at the processing center 107). Verification of the destination number can include verifying that the destination number is a valid telephone or mobile phone number; verifying that the destination number is associated with the message recipient; verifying that an account associated with the destination number is in good standing; verifying that the message recipient associated with destination number can be billed for the message, etc. Verification of the email address can include verifying that the email address is a valid email address; verifying that the message recipient associated with email address can be billed for the message, etc.

The method then proceeds to block 215 where the user can be prompted to choose a payment method for sending the message and the payment option is verified. The payment methods can include using a debit method, a pre-paid messaging option; a collect method, providing a credit or check card for sending a message, etc. For example, in one payment method, a user can add a certain dollar amount to his/her account prior to sending a message, the user's account can be debited based on the size, content or some other characteristic of the message. In this instance, verifying the payment option can include verifying that the user's account has sufficient funds.

In another payment method a debit/credit card, a bank account or a check card associated with the user's account can be charged based on the size, content or some other characteristic of the message. In this instance, verifying the payment option can include verifying that the debit/credit card, a bank account or a check card associated with the user's account is valid and in good standing.

In another payment method, the message recipient's credit/debit card or bank account can be billed based on the size, content or some other characteristic of the message. In this instance, verifying the payment option can include verifying that the debit/credit card, a bank account or a check card associated with message recipient is valid and in good standing.

In another payment method, the message recipient could have authorized including the charges incurred by the user to send the message on his/her telephone or mobile phone bill. In this instance, the message recipient's authorization can be sought or verified and/or the telephone/wireless service provider's contractual terms can be verified.

In another method, a third party (such as, for example, a bail bond company) could be charged for the message sent by the user. In some embodiments, a list of one or more third parties can be displayed on the messaging stations 101. The third party listings may be a sponsored advertisement. The third party listing can include, for example, bail bond services, legal services (listing of lawyers), or non-legal service (listing of cab companies). The messaging station 101 may be configured to directly communicate with one or more of these third party services. The third party could have rules and restrictions regarding the destination numbers/email addresses to which messages could be sent. In such instances, verifying the payment option can include verifying that the third party will pay for the message, the destination numbers/email addresses meet the third party's rules and restrictions, etc.

The method then proceeds to block 220 where the message is sent to the destination number/email address. The message can be sent using the SMS platform, the TCP/IP protocol or other platforms and protocols that can be used to send electronic messages. In various implementations, the message can be sent immediately in real time. In some implementations, the message can be stored on a remote or a local server for some time (e.g. 30 seconds, 1 minute, 5 minutes, 10 minutes, 30 minutes, 1 hour, 10 hours, 24 hours, etc.) before forwarding the message to the destination number/email address.

FIG. 3 illustrates one embodiment of a method to read a message received by a user at the messaging station 101. The user can log into the system at the messaging station 101 using a unique login and password. Any message received by the user can be displayed to the user one message at a time. The user can be provided the option to respond to the messages. In some implementations, the messaging station 101 can have one kiosk (e.g. 101a) for sending messages and a different kiosk (e.g. 101b) for checking received messages. The received messages can be stored locally or remotely for a certain period (e.g. 1 hour, 12 hours, 24 hours, 2 days, 7 days, etc.). In some implementations, the messaging station can have a public address system that includes a display to display the information associated with users who have received messages.

For the system illustrated in FIG. 1 and discussed above, in one embodiment, some of the administrative and service functions can be carried out remotely. The administrative and service functions can be performed, for example, over the internet using web interfaces 107a or 107d as shown in FIG. 1. Some of the administrative functions can include provisioning parts of the messaging station 101 or communication system 104, updating databases and lists, updating firewall settings, updating programs and software at the messaging station 101, performing routine maintenance on the gateway switches, IP router and other devices in the communication system 104, upgrading firmware and software on the gateway switches, IP router and other devices, etc.

Some of the service functions can include creating users, updating account information for the different users, recharging user accounts, reviewing past account details, review messages sent by the user, look-up the message history for any user, etc. The service functions can be performed either by a customer or an administrator at a facility where the service is provided. The customer or the administrator can open a web browser and type a web address that will direct the customer or the administrator to the web page from where service functions can be performed. For example, the customer or administrator may type “http://www.customteleconnect.com/” in the web browser. The customer or the administrator may type in any other web address as well. In some implementations, the customer or administrator can use an interface other than a web browser to provide service functions. For instance, the administrative (service or investigative) functionality described here can be implemented (e.g. in an application) in a mobile device, smartphone, table computing device, or other portable computing device.

FIG. 4 illustrates a method of providing the administrator with investigative tools to review the messages and the destination numbers/email addresses. For example, in the method illustrated in FIG. 4 the administrator at a facility (for example, a correctional facility) can access the system via a web interface or some other custom interface. The administrator can access the system by using a unique login and password combination. In various implementations, the administrator may be requested to provide additional information such as the name of the facility or a number assigned to the facility or a pin number etc. for additional security. The administrator may be allowed to access all or certain user accounts. The administrator may be allowed to review the messages sent or prior to sending for sensitive information. Based on the review, the administrator may either authorize sending the message or withholding the message. The administrators may also communicate directly with the users inside the facility.

The administrators can receive alerts of message intercepts or flags. In some embodiments, alerts can be text or email messages. The administrators can also receive alerts through an application interface on their phones. The administrator can self-program alerts, for example, based on inmate, destination number, email destination, origination or key word alerts. Investigators (or jailers) can assign an investigation number to track progress and add notes. Administrators can also search messages for specific words or phrases. Search results may be displayed with the most recent messages first. Administrators can suspend or modify user services for a specific period of time. Administrators can check the status of one or more messaging systems 101.

In various implementations, the system may be configured to allow the administrator (or an investigator) to lookup location of a device outside the facility where the messages are sent or received from by the user inside the facility. The device may include, for example, a mobile cellular device or a computer. The device may include global positioning system (GPS) functionality. The GPS information can be obtained by the messaging system 101 to lookup physical location of the device. In some implementations, the network properties of the device can also be used to identify physical location of the device. For example, internet protocol (IP) address of the device may be used by the messaging system 101 to lookup physical location of the device. Reverse Bill Name Address lookup (BNA) can also be used by the messaging system 101 to identify the recipient or sender of the message from outside the facility. Investigators can use this information to access destination party's information, including physical location.

In various implementations, the system may be configured to perform an automatic/electronic review of the message content to identify if the message includes certain keywords. For example, the message may include sensitive information such as “bomb”, “kill”, “gun”, “drugs” etc. which can be identified by an electronic review. The system may notify the administrator (for example, by a text message, an email, a page, a voice message) if a message includes certain keywords for further review. Alternately, the system can delete the message including certain keywords and not forward such messages to its destination. The system using a criteria or via an administrator input can block certain destination numbers of email addresses. The system may include a text phrase library for identifying certain keywords. The library can be continually update by contributing law enforcement.

A wide variety of alternative system configurations are possible. For example, components and devices may be added, removed, or rearranged. Similarly a wide variety of alternative methods of performing administrative, service and control functions are possible. The order of the steps illustrated in placing the calls can be rearranged and modified. Alternate validation methods and techniques can be used other than those described herein. Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

Terminology

A number of computing systems have been described throughout this disclosure. The descriptions of these systems are not intended to limit the teachings or applicability of this disclosure. For example, the user systems and worker systems described herein can generally include any computing device(s), such as desktops, laptops, video game platforms, television set-top boxes, televisions (e.g., internet TVs), computerized appliances, and wireless mobile devices (e.g. smart phones, PDAs, tablets, or the like), to name a few. Further, it is possible for the user systems described herein to be different types of devices, to include different applications, or to otherwise be configured differently. In addition, the user systems described herein can include any type of operating system (“OS”). For example, the mobile computing systems described herein can implement an Android™ OS, a Windows® OS, a Mac® OS, a Linux or Unix-based OS, or the like.

Further, the processing of the various components of the illustrated systems can be distributed across multiple machines, networks, and other computing resources. In addition, two or more components of a system can be combined into fewer components. For example, the various systems illustrated can be distributed across multiple computing systems, or combined into a single computing system. Further, various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Depending on the embodiment, certain acts, events, or functions of any of the algorithms, methods, or processes described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each process described may be implemented by one or more computing devices, such as one or more physical servers programmed with associated server code.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a” and “an” are to be construed to mean “one or more” or “at least one” unless specified otherwise.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. Thus, nothing in the foregoing description is intended to imply that any particular feature, characteristic, step, module, or block is necessary or indispensable. As will be recognized, the processes described herein can be embodied within a form that does not provide all of the features and benefits set forth herein, as some features can be used or practiced separately from others. The scope of protection is defined by the appended claims rather than by the foregoing description.

What is claimed is:

1. A messaging station to allow a user to send and receive messages to and from a remote communication device using the short messaging service (SMS) platform, the system comprising:
at least one messaging kiosk that includes:
an enclosure; and
a mobile computing device housed in the enclosure, wherein the mobile computing device comprises:
a display device;
a message input interface;
a processor; and
a communication system configured to be in communication with a message service center associated with the SMS platform.

2. The messaging station of claim 1 located in a correctional facility.

3. The messaging station of claim 2 wherein the communication system of the messaging kiosk is in communication with a central server located in the correctional facility.

4. The messaging station of claim 3 wherein a message sent or received by the user is stored on the central server and accessible to the authorities at the correctional facility for monitoring and control.

5. The messaging station of claim 4 wherein the message sent or received by the user can be monitored using a web based control and investigating portal.

6. The messaging station of claim 2 wherein the message sent or received by the user is a text message.

7. The messaging station of claim 2 wherein the message sent or received by the user is an electronic mail message.

8. The messaging station of claim 2 wherein a message recipient associated with the remote communication device is billed for a message sent by the user.

9. The messaging station of claim 2 wherein a credit card associated with a message recipient associated with the remote communication device is billed for a message sent by the user.

10. The messaging station of claim 2 configured to allow the user to purchase message credits to send messages, wherein a credit card associated with the message recipient is billed for the message credits purchased.

11. The messaging station of claim 1 configured to be accessed by a plurality of users.

12. The messaging station of claim 11 wherein each of the plurality of users can access the messaging system using a username associated with a password.

13. The messaging station of claim 12 wherein each of the plurality of users can retrieve messages sent to them by accessing the messaging system.

14. The messaging station of claim 1, wherein the display is configured to include advertising information.

15. The messaging station of claim 14, wherein the advertising information includes one or more listing of bail bond services.

16. The messaging station of claim 1, wherein the enclosure includes a base and a cover.

17. The messaging system of claim 16, wherein the mobile computing system is disposed in a recess formed in a top surface of the base.

18. The messaging system of claim 16, wherein the cover is disposed over the top surface of the base and spaced apart from the top surface by a gap.

19. The messaging system of claim 18, wherein the gap has a height that is between about 1 inch and about 6 inches.

20. The messaging system of claim 18, wherein the gap has a height such that a user can access the mobile computing system disposed in the recess.

21. The messaging system of claim 16, wherein the cover comprises a material that is transmissive to visible light.

22. The messaging system of claim 21, wherein the material is shatterproof.

23. The messaging system of claim 21, wherein the material is break resistant.

24. A method of manufacturing a messaging kiosk, the method comprising:
providing an enclosure, the enclosure comprising:
a base having a top surface and a bottom surface and a recess formed in the top surface, the recess configured to receive and accommodate a mobile computing system; and
a cover configured to be disposed over the top surface.

25. The method of claim 24, wherein the cover is spaced apart from the top surface by a gap.

26. The method of claim 25, wherein the gap has a height between about 0.5 inches and about 6 inches

27. The method of claim 24, wherein the cover comprises a material that is transmissive to visible light.

28. The method of claim 24, wherein the cover comprises a material that is break resistant.

29. The method of claim 24, wherein the cover comprises a material that is shatter proof.

30. The method of claim 24, wherein the enclosure is configured to be disposed in a correctional facility.
